(19) United States
(12) Patent Application Publication
(10) Pub. No.: US 2005/0196736 A1
(43) Pub. Date: Sep. 8, 2005

(54) Apparatus, system, and method for selectable situation coaching

(76) Inventors: Michael D. Daley, Beaverton, OR (US); Danny D. Guerrero, Tigard, OR (US)

Correspondence Address: KUNZLER & ASSOCIATES, 8 EAST BROADWAY, SALT LAKE CITY, UT, 84111, US

(21) Appl. No.: 11/039,421

(22) Filed: Jan. 20, 2005

Related U.S. Application Data
(60) Provisional application No. 60/537,742, filed on Jan. 20, 2004.

(51) Int. Cl. G09B 9/00

(52) U.S. Cl. 434/247

(57) ABSTRACT

An apparatus, system, and method are disclosed for selectable situation coaching. The apparatus includes situation identifiers having assignable values, a repository comprising a plurality of situation strategies, and a display module configured to display at least one situation strategy in response to assigned values of the plurality of situation identifiers. The system includes an electronic device and the apparatus. The method includes assigning values to a plurality of situation identifiers, maintaining a plurality of situation strategies, and displaying at least one situation strategy in response to assigned values of the plurality of situation identifiers.

### CROSS-REFERENCES TO RELATED APPLICATIONS

This application claims benefit of U.S. Provisional Patent Application No. 60/537,742 entitled “APPARATUS, SYSTEM, AND METHOD FOR SELECTABLE SITUATION COACHING DEVICE” and filed on Jan. 20, 2004 for Michael D. Daley and Danny D. Guerrero, which is incorporated herein by reference.

### BACKGROUND OF THE INVENTION

1. Field of the Invention

This invention relates to coaching athletic sports and more particularly relates to an apparatus for selectable situation coaching.

2. Description of the Related Art

In the early 1900's, organized sports in this country were initiated and sponsored by government agencies as a way to keep boys from getting into trouble. Currently, however, almost 40 million youth, aged 5-17, participate in organized sports. Today sports programs serve the purpose of providing youth with sports skills along with opportunities to compete in controlled environments. Organized sports for youth can help build dexterity and improve social skills.

Sports can also promote good health among both adults and youth. In March of 1997, the Centers for Disease Control and Prevention published “Guidelines for Schools and Communities for Promoting Lifelong Physical Activity.” According to the guide, regular activity during childhood and adolescence improves strength and endurance, helps build healthy bones and muscles, helps control weight, and increases self-esteem. Additionally, the guide states that sports program coordinators can increase activity among youth by providing a “mix of competitive team and non competitive, lifelong fitness and recreational activities,” and guarantee that coaches are competent.

Ensuring that children and adolescents have good, positive experiences is key to improving their health and confidence. The coach bears this burden. More than 2 million adults volunteer their time each year as coaches and assistants of youth teams. While this is admirable, the volunteers typically have no formal training on how to be a coach, and additionally many times have not even played the sport. These volunteer coaches lack the competence to teach the skills and proper reaction to certain situations. For example, the average youth baseball coach does not know how every position should be played when there is a runner at first and two outs. The youth will likewise not know the proper reaction, for example, throw to first base, if the coach does not know.

In order to teach these skills a few training programs have been established for coaches. However, volunteer coaches generally have limited time, and therefore the extra time a coach does have is spent coaching the team and not in training programs. As a result, an estimated 90% of coaches have no formal training in coaching techniques and skills.

An alternative to training programs may be sports-themed video games. Sports-themed video games attempt to emulate actual games. Many youth and adults alike play football, basketball, baseball, and soccer video games. The video games even simulate an entire season, enabling the youth or adult to trade players and manage the team. However, video games do not teach proper techniques or reactions in particular situations. Additionally, video games at a practice would be a major distraction to youth instead of an aid in learning how to play the sport.

From the foregoing discussion, it should be apparent that a need exists for an apparatus, system, and method for selectable situational coaching. Beneficially, such an apparatus, system, and method would allow a player or coach to input unique situations and return details on how to play a specific position.

### SUMMARY OF THE INVENTION

The present invention has been developed in response to the present state of the art, and in particular, in response to the problems and needs in the art that have not yet been fully solved by currently available coaching devices. Accordingly, the present invention has been developed to provide an apparatus, system, and method for selectable situation coaching that overcome many or all of the above-discussed shortcomings in the art.

The apparatus is provided with a logic unit containing a plurality of modules configured to functionally execute the necessary steps of selectable situation coaching. These modules in the described embodiments include a plurality of situation identifiers, each having a plurality of assignable values, a repository comprising a plurality of situation strategies, and a display module configured to display at least one situation strategy in response to assigned values of the plurality of situation identifiers.

In one embodiment, the plurality of assignable values may comprise athletic game environment values. The display module may also be configured to receive input from a user that defines the assignable values. In a further embodiment, the situation strategy comprises a suggested reaction to a combination of situation identifier values. Additionally, the apparatus may include a strategy module configured to maintain a plurality of unique identifiers, each unique identifier comprising a unique combination of values for situation identifiers.

The apparatus may also include a repository interface module configured to receive the unique identifier and retrieve the corresponding situation strategy from the repository. The display module may be configured to randomly define a unique identifier and display the corresponding situation strategy from the repository. Alternatively, the display module may be configured to sequentially define a unique identifier and display the corresponding situation strategy from the repository.

A system of the present invention is also presented. The system, in one embodiment, includes an electronic device, a plurality of situation identifiers, each having a plurality of assignable values, a repository comprising a plurality of situation strategies, and a display module configured to display at least one situation strategy in response to assigned values of the plurality of situation identifiers.

In one embodiment, the plurality of assignable values may comprise athletic game environment values. The display module may also be configured to receive input from a user that defines the assignable values. In a further embodiment, the situation strategy comprises a suggested reaction to a combination of situation identifier values. Additionally, the system may include a strategy module configured to maintain a plurality of unique identifiers, each unique identifier comprising a unique combination of values for situation identifiers.

The system may also include a repository interface module configured to receive the unique identifier and retrieve the corresponding situation strategy from the repository. The display module may be configured to randomly define a unique identifier and display the corresponding situation strategy from the repository. Alternatively, the display module may be configured to sequentially define a unique identifier and display the corresponding situation strategy from the repository.

A method of the present invention is also presented. The method in the disclosed embodiments substantially includes the steps necessary to carry out the functions presented above with respect to the operation of the described apparatus and system. In one embodiment, the method includes assigning values to a plurality of situation identifiers, maintaining a plurality of situation strategies, and displaying at least one situation strategy in response to assigned values of the plurality of situation identifiers.

In a further embodiment, the method includes receiving input from a user that defines the assignable values, and randomly defining a unique identifier and displaying a situation strategy from the repository. Additionally, the method may include sequentially defining a unique identifier and displaying a situation strategy from the repository.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a coaching apparatus in accordance with the present invention;

FIG. 2 is a schematic block diagram illustrating one embodiment of a coaching module in accordance with the present invention;

FIG. 3 is a schematic flow chart diagram illustrating one embodiment of a method for selectable situation coaching in accordance with the present invention;

FIG. 4 is a schematic flow chart diagram illustrating one embodiment of a method for assigning values to a plurality of situation identifiers;

FIG. 5 is a schematic block diagram illustrating one embodiment of a screenshot of the coaching apparatus in accordance with the present invention;

FIG. 6a is a schematic block diagram illustrating an alternative embodiment of a screenshot of the coaching apparatus in accordance with the present invention; and

FIG. 6b is a schematic block diagram illustrating another embodiment of a screenshot of the coaching apparatus in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, repository queries, repository structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

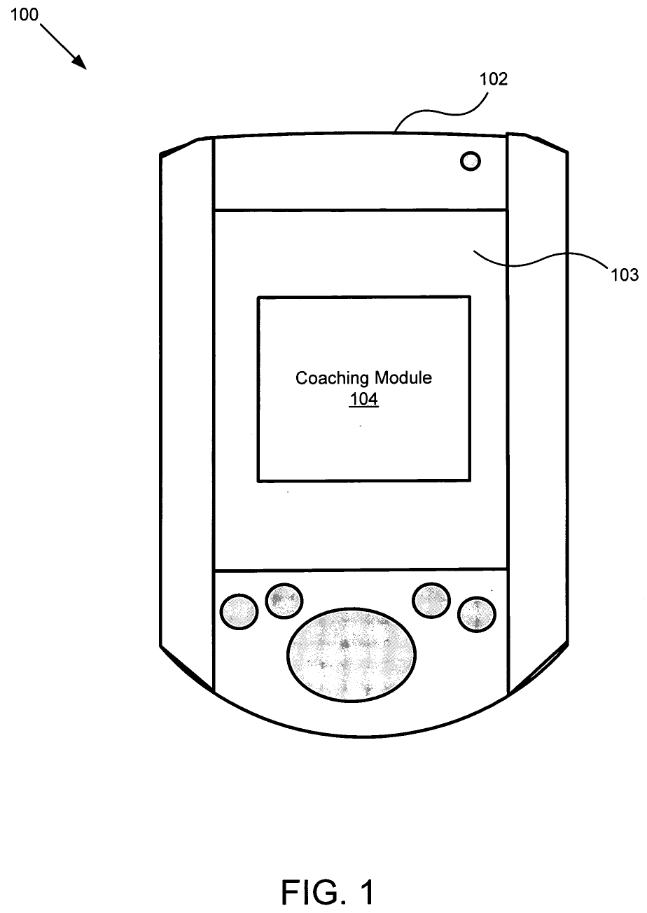

FIG. 1 is a schematic block diagram illustrating one embodiment of the coaching apparatus 100 of the present invention. In one embodiment, the coaching apparatus 100 may comprise a handheld computing device 102 having a screen 103. The screen 103 may be a touch-screen configured to receive input from a user. Such screens are well known in the art and do not require further discussion herein. The handheld computing device 102 may be configured to function with an operating system such as, but not limited to, Microsoft Pocket PC 2003™, and Palm OS™. The coaching apparatus 100 may comprise a coaching module 104. In a further embodiment, the coaching module 104 is configured to operate on a mobile phone, computer, gaming console, dummy terminal, or other handheld electronic device.

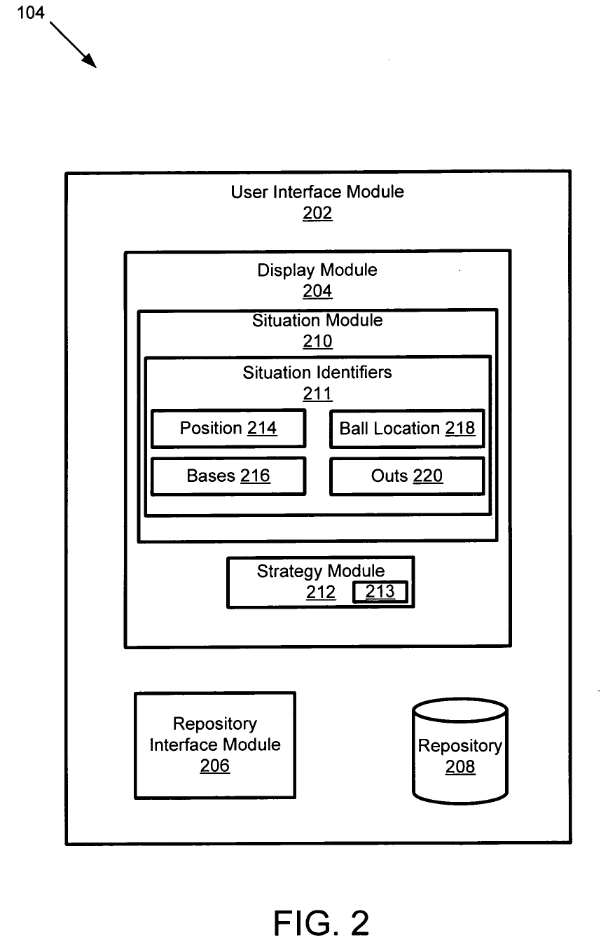

Referring now to FIG. 2, shown therein is a schematic block diagram illustrating one embodiment of the coaching module 104 of the present invention. The coaching module 104 may comprise a user interface module 202. The user interface module 202 is configured to receive input from a user. In the above described embodiment, such input may be received as the user writes or taps on the screen 103. Alternatively, keys or buttons may provide the input.

The user interface module 202 may also comprise a display module 204, repository interface module 206, and a repository 208. Additionally, the display module 204 may comprise a situation module 210 having situation identifiers 211. Situation identifiers 211 may comprise any facts or circumstances relevant to making a coaching decision. For example, the coaching module 104 may be configured for baseball. The situation identifiers 211 for baseball may be the position 214 of the player to be coached, the bases 216 occupied by runners, the location 218 of the ball, and how many outs 220 there are. Alternatively, the situation identifiers 211 may be configured for any sport such as, but not limited to, basketball, football, hockey, volleyball, and soccer.

Each of the situation identifiers 211 may have a plurality of possible values. For example, the position identifier 214 may comprise nine values corresponding to the first base player, the second base player, the third base player, the pitcher, the catcher, etc. Additionally, each of the situation identifiers 211 may have a plurality of values depending on the chosen sport.

The display module 204 is configured to receive user input and subsequently assign values defined by the input to the situation identifiers 211. In one embodiment, the situation identifiers 211 may comprise drop down menus (not shown) configured to display available values. For example, upon selecting outs 220, a drop down menu is displayed and the user may choose 0 outs, 1 out, or 2 outs.

A strategy module 212 may be configured to store a plurality of unique identifiers 213. Each unique identifier 213 comprises a unique combination of situation identifiers 211. In one embodiment, the repository interface module 206 is configured to receive the unique identifier 213 and retrieve a corresponding situation strategy from the repository 208. One skilled in the art will recognize that the repository 208 may be replaced with a database or, alternatively, configured as a lookup table. The display module 204 then displays the situation strategy to the user.

A situation strategy may comprise text describing the play strategy a player should take in a particular situation. Alternatively, the situation strategy may include an audio prompt describing the strategy, video of the strategy being performed, a graphic or animation displaying the strategy, or any combination thereof.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

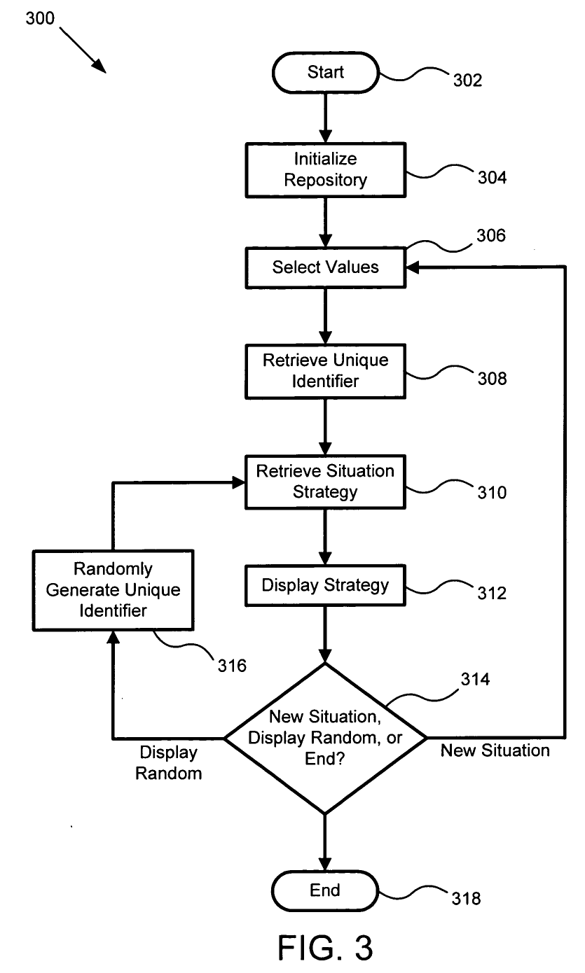

FIG. 3 is a schematic block diagram illustrating one embodiment of a method 300 for selectable situation coaching of the present invention. The method 300 starts 302 and the repository 208 may be initialized 304. A user may then select 306 values for the situation identifiers 211. Once the situation identifiers 211 are selected 306, the strategy module 212 may then retrieve 308 the unique identifier 213, and pass the unique identifier 213 to the repository interface module 206.

Using the unique identifier 213, the repository interface module 206 retrieves 310 the corresponding situation strategy from the repository and displays 312 the strategy to the user. The situation strategy may be automatically displayed or, alternatively, in response to user input. At this point, the user may choose 314 to display a new situation strategy, display a random situation strategy from the repository, display a subsequent situation strategy from the repository, or end 318.

If the user chooses 314 to display a new situation, the user simply assigns 306 new values to the situation identifiers 211 and proceeds as described above. The coaching module 104 may be configured to randomly generate 316 unique identifiers 213. A user may desire to practice by reviewing situations and therefore the coaching module 104 may be configured to display randomly selected situations and the corresponding situation strategies. Alternatively, the coaching module 104 may be configured to systematically change the value of situation identifiers 211, effectively walking the user through situation strategies. For example, the user may be presented with the same situation where a ball is hit to right field, but the situation strategy subsequently changes in response to the first out, and then the second out. In a further embodiment, the user may end 318 the method 300.

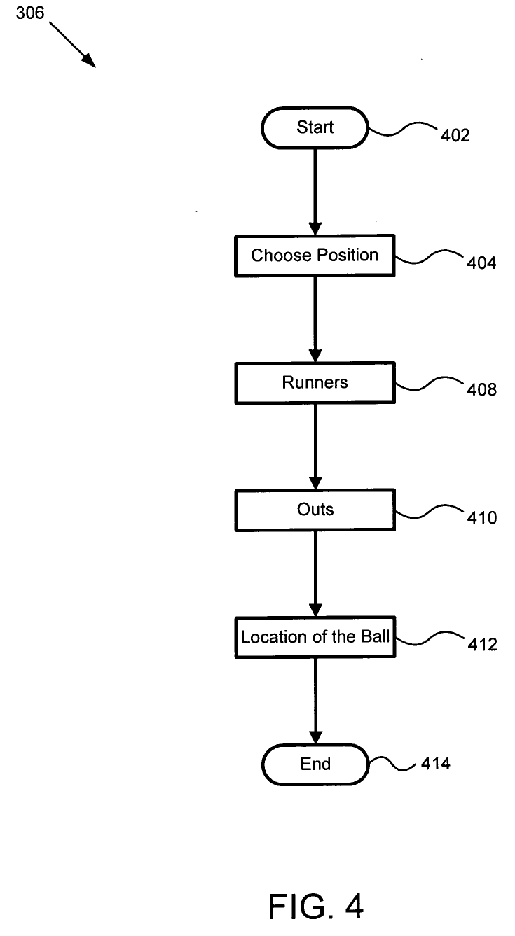

FIG. 4 is schematic flow chart diagram illustrating one embodiment of the method 306 for assigning values of situation identifiers 211. In one embodiment, the method 306 starts 402, and the user chooses 404 or selects the position of a player within the situation. The user then chooses 408 how many runners are on bases, chooses 410 how many outs, and chooses 412 the location of the field the ball is hit to. For example, if a coach chooses 404 first base as the position, chooses 408 runners on first and third base, chooses 410 two outs, and chooses 412 a ground ball hit to the right of the infield, the display module 204 may display a situation strategy such as “Get the 3^{rd} out—the play is at 1^{st}.”Alternatively, the user may assign values to the situation identifiers 211 in any order, and is not restricted to first assigning 406 random or sequential situations.

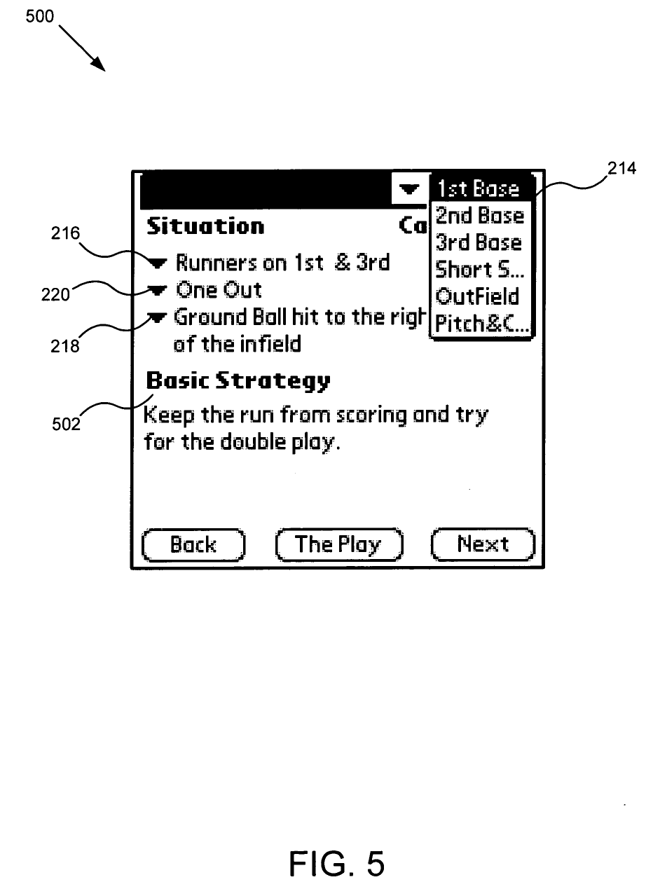

FIG. 5 is a schematic block diagram illustrating one embodiment of a screenshot 500 of the present invention. In one embodiment, the screen 103 of the device is configured to display a plurality of dropdown menus. As depicted, each situation identifier 214, 216, 218, 220 may have a corresponding dropdown menu. The situation identifiers 214, 216, 218, 220 are selectable using a touch screen apparatus, such as a stylus (not shown) or other input device. In a further embodiment, the situation identifiers may be selectable as described above with reference to FIG. 4, or alternatively the situation identifiers 214, 216, 218, 220 may be chosen in any order. A basic strategy 502 is displayed according to the values selected.

The situation strategy may comprise a basic strategy 502 or a situation specific strategy. A basic strategy 502 provides general guidance regarding coaching. A situation specific strategy may provide coaching instruction relate to a particular situation identifier, such as a player position.

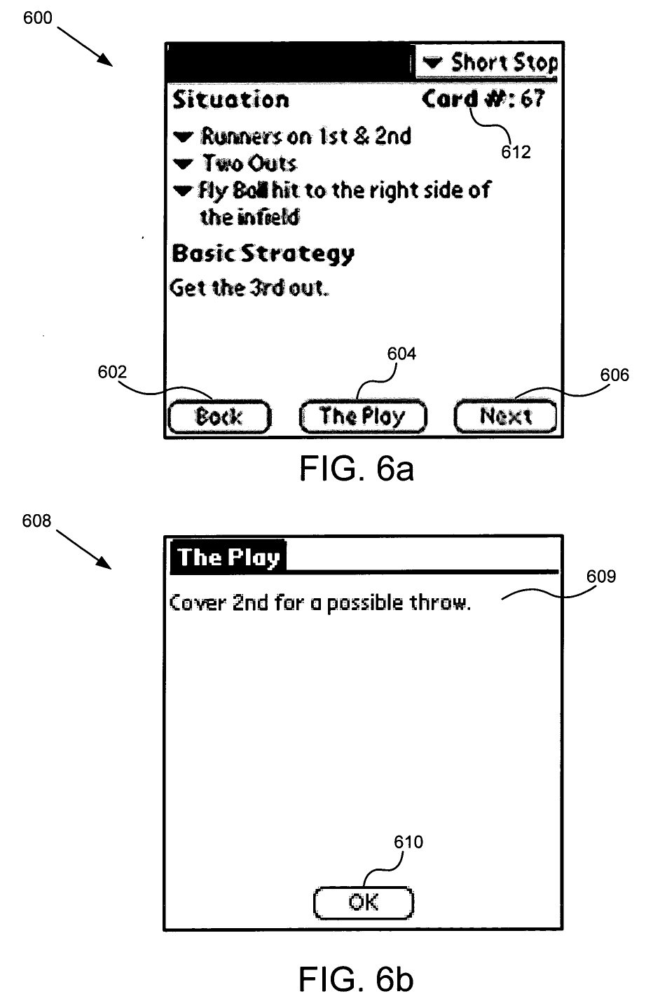

FIGS. 6a and 6b are schematic block diagrams illustrating one embodiment of screenshots 600 and 608 of the present invention. Once the situation identifiers 214, 216, 218, 220 are selected, the user may then select “The Play” 604, and an advanced situation specific strategy 609 is displayed as illustrated in FIG. 6b. Selecting “OK” 610 will return the user to the previous screen where a new situation may be selected. Alternatively, the user may browse situations by pressing “Next” 606 or “Back” 602. If the user has chosen sequential, pressing “Next” 606 will return the subsequent situation strategy in the repository 208. Likewise, “Back” 602 will return the preceding situation strategy. However, if the user has chosen 406 random, pressing “Next” 606 or “Back” 602 will return situation strategies randomly selected by the strategy module 212.

The repository 208 containing the plurality of situations may be represented as a plurality of cards 612. In one embodiment, the plurality of cards 612 may be printed and arranged in a manner similar to flash cards. Selecting “Next” 606 or “Back” 602 returns the subsequent or preceding card accordingly. For example, as depicted, the position is short stop, there are runners on 1^{st} and 2^{nd}, there are two outs, and a fly ball is hit to the right side of the infield. The returned situation strategy is Card #67, “Cover 2^{nd} for a possible throw.” After viewing the strategy, if the user selects “Next” 606 Card #68 will be displayed, and likewise “Back” 602 will return Card #66.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for selectable situation coaching, the apparatus comprising:
a plurality of situation identifiers, each having a plurality of assignable values;
a repository comprising a plurality of situation strategies; and
a display module configured to display at least one situation strategy in response to assigned values of the plurality of situation identifiers.

2. The apparatus of claim 1, wherein the plurality of assignable values further comprise athletic game environment values.

3. The apparatus of claim 1, wherein the display module is further configured to receive input from a user that defines the assignable values.

4. The apparatus of claim 1, wherein the situation strategy comprises a suggested reaction to a combination of situation identifier values.

5. The apparatus of claim 1, further comprising a strategy module configured to maintain a plurality of unique identifiers, each unique identifier comprising a unique combination of values for situation identifiers.

6. The apparatus of claim 1, further comprising a repository interface module configured to receive the unique identifier and retrieve the corresponding situation strategy from the repository.

7. The apparatus of claim 1, wherein the display module is configured to randomly define a unique identifier and display the corresponding situation strategy from the repository.

8. The apparatus of claim 1, wherein the display module is configured to sequentially define a unique identifier and display the corresponding situation strategy from the repository.

9. A system for selectable situation coaching, the system comprising:
an electronic device;
a plurality of situation identifiers, each having a plurality of assignable values;
a repository comprising a plurality of situation strategies; and
a display module configured to display at least one situation strategy in response to assigned values of the plurality of situation identifiers.

10. The system of claim 9, wherein the plurality of assignable values further comprise athletic game environment values.

11. The system of claim 9, wherein the display module is further configured to receive input from a user that defines the assignable values.

12. The system of claim 9, wherein the situation strategy comprises a suggested strategy to a combination of situation identifier values.

13. The system of claim 9, further comprising a strategy module configured to maintain a plurality of unique identifiers, each unique identifier comprising a unique combination of values for situation identifiers.

14. The system of claim 9, further comprising a repository interface module configured to receive the unique identifier and retrieve the corresponding situation strategy from the repository.

15. The system of claim 9, wherein the display module is configured to randomly define a unique identifier and display the corresponding situation strategy from the repository.

16. The system of claim 9, wherein the display module is configured to sequentially define a unique identifier and display the corresponding situation strategy from the repository.

17. A computer readable storage medium comprising computer readable code configured to carry out a method for selectable situation coaching, the method comprising:
assigning values to a plurality of situation identifiers;
maintaining a plurality of situation strategies; and
displaying at least one situation strategy in response to assigned values of the plurality of situation identifiers.

18. The method of claim 16, further comprising receiving input from a user that defines the assignable values.

19. The method of claim 16, further comprising randomly defining a unique identifier and displaying a situation strategy from the repository.

20. The method of claim 16, sequentially defining a unique identifier and displaying a situation strategy from the repository.
